(19) United States
(12) Patent Application Publication
(10) Pub. No.: US 2005/0000536 A1
(43) Pub. Date: Jan. 6, 2005

(54) Notorious hair designs

(76) Inventor: Frederick James Notorio, Scottsdale, AZ (US)

Correspondence Address: Frederick Notorio, 10547 E. Cannon Drive, Scottsdale, AR, 85258, US

(21) Appl. No.: 10/870,767

(22) Filed: Jun. 17, 2004

Related U.S. Application Data
(60) Provisional application No. 60/480,531, filed on Jun. 23, 2003.

(51) Int. Cl. B26B 21/00

(52) U.S. Cl. 132/213; 30/32

(57) ABSTRACT

Notorious Hair Designs is a series of templates and/or guides used in conjunction with an electrical or battery powered hair trimmer to produce specific designs in body hair. One of the templates/guides is placed over an area of body hair and the hair trimmer is used to remove all hair surrounding the template and not covered by the guide. Thereby producing the design of the template in the form of the remaining body hair.

### CROSS-REFERENCE TO RELATED APPLICATIONS

This application claims, through said U.S. patent application, priority to and the benefit of U.S. provisional patent application Ser. No. 60/480,531, filed Jun. 23, 2003, which U.S. provisional patent application is incorporated herein by reference in its entirety.

### BACKGROUND OF THE INVENTION

This invention relates to the field of self-grooming devices. More specifically, the invention relates to hair guides, electrical and battery operated hair trimming devices and manual (scissor) hair trimming devices.

U.S. Patent Documents Referenced

| | |
|---|---|
| 3928871 | Wall |
| 2917055 | Fouche |
| 2670744 | Levin |
| 4520565 | Maggiore |
| 6135123 | Grassi and Kovach |

U.S. Pat. No. 3,928,871 to Wall illustrates a barber's glove that is worn over the hand of a barber. The glove includes adjacent fingers for controlling the hair being cut. Other hair cutting guides are shown in U.S. Pat. No. 2,917,055 to Fouche and U.S. Pat. No. 2,670,744 to Levin.

U.S. Pat. No. 4,520,565 to Maggiore illustrates a hair cutting guide apparatus which provides an even cut of the hair by spacing or by controlling the distance that the hair is cut away from the persons head. The patent to Maggiore does disclose a pivot means about which two fingers may be rotated.

U.S. Pat. No. 6,135,123 to Grassi and Kovach illustrates a hair-cutting guide comprised of an upper and lower clip interconnected by a pivot pin allowing each to pivot with respect to the other.

The foregoing patents have as their goal cutting hair to uniform length. None of the prior art discloses a haircutting guide that is comprised of a template that when placed over an area of body hair provides a guide around which all the surrounding body hair is removed by a trimmer or scissor; leaving body hair in the design of the template.

### BRIEF SUMMARY OF THE INVENTION

Problem

Prior to this design, people were forced to develop a free hand design in body hair either by himself or herself or through the employment of a hairstylist. Applying the design by using either a razor, clipper, or scissor. This limited the ability of a number of people to participate either because they were incapable of performing the art themselves or could not afford the services of a hair stylist.

Solution: Therefore, what has been needed is a design that would allow a large number of people to participate in this art at an affordable price.

It is the object of the present invention to make available a hair-cutting guide that provides surfaces that guide a razor, clipper, and/or scissor.

It is the object of the present invention to make available a hair-cutting guide that makes the design and implementation of images in body hair easy and affordable.

The objects of the invention will be better understood when taken in conjunction with the Brief Description of the Drawings and the Detailed Description of the Invention that follow.

### BRIEF DESCRIPTION OF THE SEVERAL VIEWS OF THE DRAWING

FIG. 1 is an example of a template containing 9 designs.

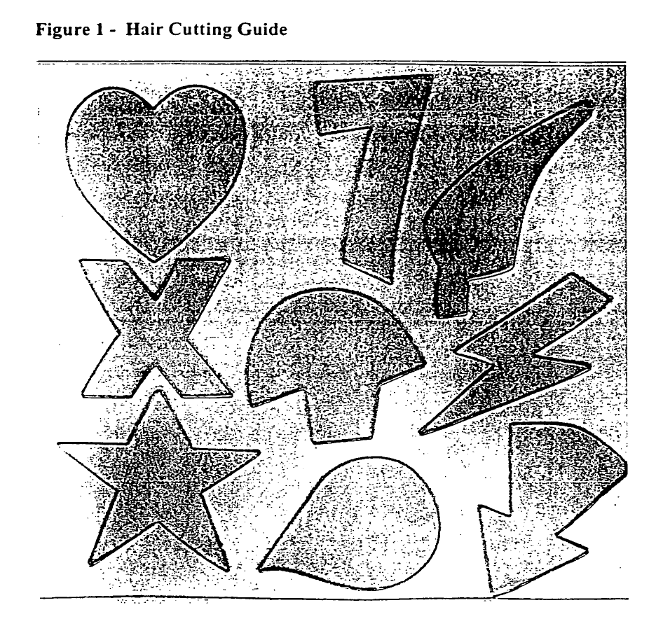

FIG. 2 is an example of the template in FIG. 1 with one of the designs removed.

FIG. 3 is an example of a battery powered hair trimmer.

### DETAILED DESCRIPTION OF THE INVENTION

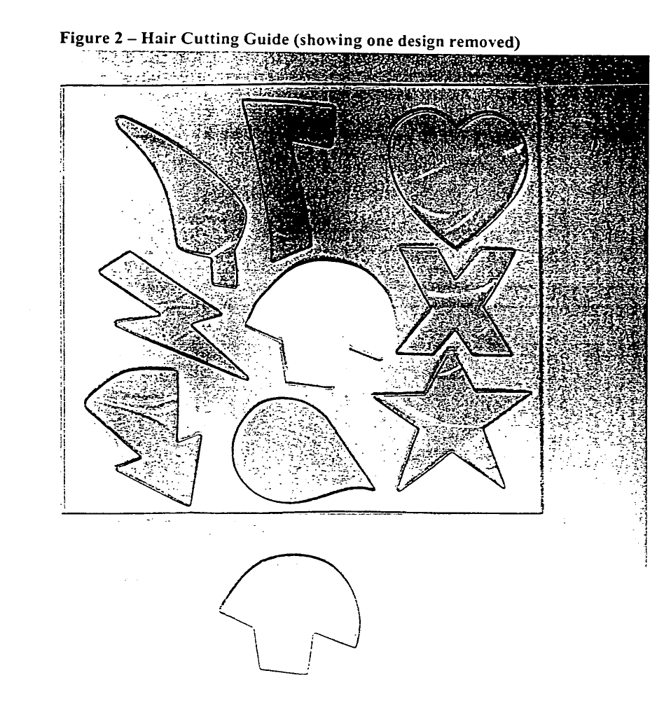

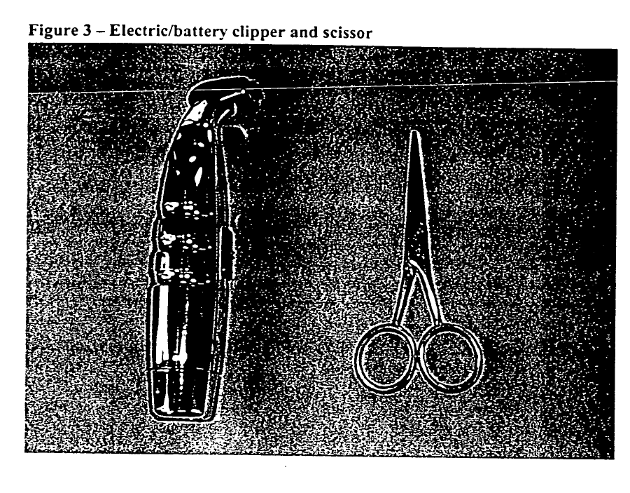

The design that has been removed (as shown in FIG. 2) is placed over the body hair that will produce the final desired image. Using a razor, scissor, or trimmer as depicted in FIG. 3, the body hair in the immediate area around the design is removed. This leaves the image of the design in the form of the remaining body hair.

As an alternative, the vacated area left in the template after the design is removed, may be placed over the area of the body hair. All of the hair inside the template is then removed leaving the design as a silhouette in the remaining body hair.

### DESCRIPTION OF THE PREFERRED EMBODIMENT

In the preferred embodiment the template is manufactured from plastic using a tool and die press to eradicate the desired designs in the sheets of plastic.

It will be understood by those skilled in the art that the template could be made from many different materials.

It will be understood by those skilled in the art that many changes and modifications may be made to the invention without departing from the spirit and scope of the appended claims.

It will be understood by those skilled in the art that the invention has been set forth by way of example only and the foregoing example is not meant to act in any way as a limitation o the scope of the appended claims.

1. A hair-cutting guide comprised of a number of easily removable designs contained in a template sheet.

2. A razor, clipper, and/or scissor capable of cutting body hair.

3. A hair-cutting guide as claimed in claim 1 and a trimmer as claimed in claim 2 that can be used by a single individual to produce body hair art on their person.
